(19) United States
(12) Patent Application Publication
(10) Pub. No.: US 2020/0298858 A1
(43) Pub. Date: Sep. 24, 2020

(54) METHODS AND SYSTEMS FOR LANE CHANGE ASSISTANCE FOR A VEHICLE

(71) Applicant: HERE GLOBAL B.V., Eindhoven (NL)

(72) Inventors: Leon STENNETH, Chicago, IL (US); Zhenhua ZHANG, Chicago, IL (US)

(21) Appl. No.: 16/358,386

(22) Filed: Mar. 19, 2019

(51) Int. Cl. B60W 30/18; G08G 1/16; G05D 1/00; G06K 9/00

(52) U.S. Cl. CPC B60W 30/18163; G08G 1/167; G05D 1/0088; B60W 2550/22; G05D 2201/0213; B60W 2550/10; G06K 9/00805

(57) ABSTRACT

The disclosure provides a method, a system, and a computer program product in accordance with at least one example embodiment for generating lane change action data for an autonomous vehicle. The solution includes a method of identifying one or more road objects and determining road object data. The method further includes determining drive condition data corresponding to an environment in which the autonomous vehicle is located. Furthermore, a step of generating lane change action data is triggered based on the determined drive condition data. The generated lane change action data instructs the autonomous vehicle on whether or not to change a lane in an overtake prohibition zone.

### TECHNOLOGICAL FIELD OF THE INVENTION

The present disclosure generally relates to a driving assistance solution, and more particularly to a system, a method, and a computer program product for generating lane change action data for an autonomous vehicle.

### BACKGROUND

As the core of smart driving, autonomous vehicles or driverless vehicles have become the most concerned technology. The technology includes artificial intelligence (AI), where the AI with respect to vehicles may be defined as the ability of the autonomous vehicle to think, learn and make decisions independently. In general use, an AI enabled vehicle may refer to an autonomous vehicle which mimics human cognition in terms of taking driving decisions. The driving decision may be required at every turn of events, for example, speed deceleration of the autonomous vehicle when encountered with a speed breaker on the travelling lane, or detecting road condition including blockage, accidents or detecting right of way at intersections, etc.

Though, the autonomous vehicles have evolved over time, there are numerous areas that still require automation. For example, lane change may be the most common behavior in driverless situation that greatly affects the road efficiency of autonomous vehicles. Fast and safe lane change operations have very practical significance in reducing traffic accidents. In certain conditions a real time traffic condition such as a blockage in an overtake prohibition zone could lead the autonomous vehicle to remain on the same lane for hours as overtaking the blockage in the overtake prohibition zone may not be prioritized.

### BRIEF SUMMARY OF THE INVENTION

A method, a system, and a computer program product are provided in accordance with an example embodiment described herein for generating lane change action data for an autonomous vehicle. Considering the currently available autonomous vehicles, there is a need for a solution that is efficient in handling sensitive conditions such as overtaking a blockage in an overtake prohibition zone on a road.

Embodiments of the disclosure provide a system for generating lane change action data for an autonomous vehicle, the system comprising a memory configured to store computer program code and one or more processors configured to execute the computer program code. The processor is configured to receive road object data of a current lane of the autonomous vehicle, wherein the road object data corresponds to a no-overtake instruction in the current lane and determine drive condition data of the autonomous vehicle, based on the road object data. Further, the processor is configured to generate the lane change action data, based on the drive condition data.

According to one embodiment, to determine the drive condition data, the one or more processors are further configured to determine a degree of blockage of the current lane of the autonomous vehicle.

According to one embodiment, to determine the drive condition data, the one or more processors are further configured to determine neighboring lane presence data for the autonomous vehicle, based on the degree of blockage that is greater than or equal to a threshold level of blockage.

According to one embodiment, to generate the lane change action data, the one or more processors are further configured to generate an instruction to the autonomous vehicle to continue in the current lane, based on the degree of blockage that is less than a threshold level of blockage.

According to one embodiment, to determine the drive condition data, the one or more processors are further configured to determine physical divider presence data for the autonomous vehicle, based on the neighboring lane presence data that indicates presence of a neighboring lane adjacent to the current lane of the autonomous vehicle.

According to one embodiment, to generate the lane change action data, the one or more processors are further configured to generate a notification message indicating possible delay, based on the neighboring lane presence data that indicates absence of a neighboring lane adjacent to the current lane of the autonomous vehicle.

According to one embodiment, to determine the drive condition data, the one or more processors are further configured to determine opposing traffic congestion data on the neighboring lane, based on the physical divider presence data that indicates absence of a physical divider between the current lane and the neighboring lane.

According to one embodiment, to generate the lane change action data, the one or more processors are further configured to generate a notification message indicating possible delay, based on the physical divider presence data that indicates presence of a physical divider between the current lane and the neighboring lane.

According to one embodiment, to generate the lane change action data, the one or more processors are further configured to generate an instruction to the autonomous vehicle to transition from the current lane to the neighboring lane, based on the opposing traffic congestion data that indicates a degree of opposing traffic congestion is less than or equal to a threshold level of opposing traffic congestion.

According to one embodiment, to generate the lane change action data, the one or more processors are further configured to generate a wait notification, based on the opposing traffic congestion data that indicates a degree of opposing traffic congestion is greater than a threshold level of opposing traffic congestion.

Embodiments of the disclosure provide a method for generating lane change action data for an autonomous vehicle. The method comprises receiving road object data of a current lane of the autonomous vehicle, wherein the road object data corresponds to a no-overtake instruction in the current lane and determining drive condition data of the autonomous vehicle, based on the road object data. Further, the method comprises generating the lane change action data, based on the drive condition data.

Embodiments of the disclosure provide a computer program product comprising at least one non-transitory computer-readable storage medium having stored thereon computer-executable program code instructions which when executed by a computer, cause the computer to carry out operations for generating lane change action data for an autonomous vehicle. The operations comprise receiving road object data of a current lane of the autonomous vehicle, determining drive condition data of the autonomous vehicle, based on the road object data, and generating the lane change action data for the autonomous vehicle based on the drive condition data.

### BRIEF DESCRIPTION OF THE DRAWINGS

Having thus described example embodiments of the disclosure in general terms, reference will now be made to the accompanying drawings, which are not necessarily drawn to scale, and wherein:

FIG. 1 illustrates a schematic diagram of an environment for generating lane change action data for an autonomous vehicle, according to at least one embodiment of the present disclosure;

FIG. 2 illustrates a schematic diagram of an embodiment of an environment for generating lane change action data for an autonomous vehicle, in accordance with an example embodiment;

FIG. 3 illustrates a block diagram of a driving assistance system configured within the an autonomous vehicle of FIG. 2, in accordance with an example embodiment;

FIG. 4 illustrates a block diagram of a system for generating lane change action data for an autonomous vehicle of FIG. 2, in accordance with an example embodiment;

FIG. 5 illustrates a block diagram representation of a process of generating the drive condition data, in accordance with an example embodiment;

FIG. 6 shows a block diagram representing a method for determining the lane change action, in accordance with an example embodiment;

FIG. 7 shows a flow diagram representing a process of generating lane change action data, in accordance with an example embodiment; and

FIG. 8 shows a flow diagram representing a process of generating lane change action data in furtherance to FIG. 7, in accordance with an example embodiment.

### DETAILED DESCRIPTION OF THE INVENTION

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments. As used herein, the terms “data,” “content,” “information,” and similar terms may be used interchangeably to refer to data capable of being displayed, transmitted, received and/or stored in accordance with embodiments of the present disclosure. Thus, use of any such terms should not be taken to limit the spirit and scope of embodiments of the present disclosure.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

### Definitions

The term “road” may be used to refer to a way leading an autonomous vehicle from one place to another place. The road may have a single lane or multiple lanes.

The term “lane” may be used to refer to a part of a road that is designated for travel of vehicles.

The term “autonomous vehicle” may be used to refer to a vehicle having fully autonomous or semi-autonomous driving capabilities at least in some conditions with minimal or no human interference. For example, an autonomous vehicle is a vehicle that drives and/or operates itself without a human operator but may or may not have one or more passengers.

The term “current lane” may be used to refer a lane of a road on which an autonomous vehicle is located.

The term “neighboring lane” may be used to refer to at least one lane of a road which is adjacent to the current lane.

The term “road object” may be used to refer any road indication that corresponds to no overtake message. For example, road object may be, but not limited to, a “no overtake” sign board, lane markings, a “no overtake” display, etc.

The term “road object data” may be used to refer to observation data related to one or more road objects associated with the current lane.

The term “physical divider” may be used to refer an object that prohibits maneuver of an autonomous vehicle from a current lane to a neighboring lane. For example, physical dividers may be, but not limited to, temporary raised islands, lane dividers, pavement markings, delineators, lighting devices, traffic barriers, control signals, crash cushions, rumble strips, shields, etc.

The term “physical divider presence data” may be used to refer to data corresponding to presence or absence of the physical divider between the current lane and the neighboring lane.

The term “lane change action data” may be used to refer to instructions to an autonomous vehicle to whether or not to change lane in a no overtake zone based on the road object data.

The term “overtake prohibited zone” may be used to refer to a segment of a road that comprises a road object to indicate an autonomous vehicle, the restriction on action of going past another slower moving vehicle in the same lane.

### End of Definitions

A solution including a method, a system, and a computer program product are provided herein in accordance with at least one example embodiment for generating lane change action data for an autonomous vehicle. The solution includes a method of identifying one or more road objects and determining road object data. The method further includes determining drive condition data corresponding to an environment in which the autonomous vehicle is located. Furthermore, a step of generating the lane change action data is triggered based on the determined drive condition data. The generated lane change action data is defined to instruct the autonomous vehicle on whether to change lane in an overtake prohibition zone.

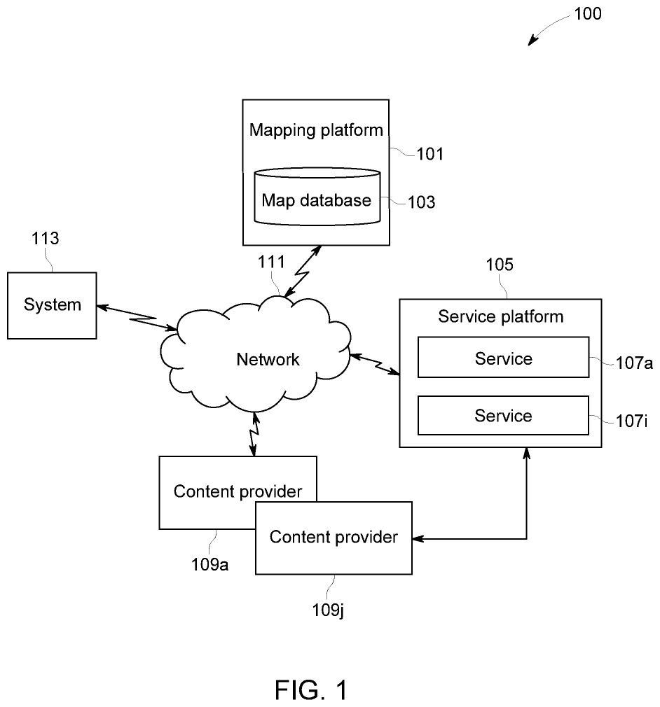

The system, the method, and the computer program product facilitating generation of the lane change action data of an autonomous vehicle are described with reference to FIG.1 to FIG. 8.

FIG. 1 illustrates a schematic diagram of an environment 100 describing at least one embodiment of the present disclosure to generate the lane change action data. With reference to FIG. 1, the environment 100 may include a mapping platform 101, a map database 103, a services platform 105 providing services 107a to 107i, a plurality of content providers 109a to 109j, a network 111, and a system 113 for generating lane change action data. In an embodiment, the system 113 is deployed in an autonomous vehicle to generate the lane change action data. The autonomous vehicle may be carrying one or more passengers from a source location to a destination location in a current lane of the road. In an embodiment, the autonomous vehicle may or may not support manual interference from any of the passengers in the process of navigation in the current lane.

All the components, that is, 101, 103, 105, 109a-109j 111, and 113 in the environment 100 may be coupled directly or indirectly to the network 111. The components described in the environment 100 may be further broken down into more than one component and/or combined together in any suitable arrangement. Further, one or more components may be rearranged, changed, added, and/or removed.

The system 113 is in communication with the mapping platform 101 over the network 111. The network 111 may be a wired communication network, a wireless communication network, or any combination of wired and wireless communication networks, such as, cellular networks, Wi-Fi, internet, local area networks, or the like. In one embodiment, the network 111 may include one or more networks, such as, a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof

As exemplarily illustrated, the mapping platform 101 includes the map database 103, which may store node data, road segment data or link data, point of interest (POI) data, posted signs related data, lane data which includes details on number of lanes of each road and passing direction, or the like. Also, the map database 103 further includes speed limit data of each lane, cartographic data, routing data, and/or maneuvering data. Additionally, the map database 103 is updated dynamically to cumulate real time traffic conditions. The real time traffic conditions are collected by analyzing the location transmitted to the mapping platform 101 by a large number of road users through the respective user devices of the road users. In one example, by calculating the speed of the road users along a length of road, the mapping platform 101 generates a live traffic map, which is stored in the map database 103 in the form of real time traffic conditions. The real time traffic conditions update the autonomous vehicle on slow moving traffic, lane blockages, under construction road, freeway, right of way, and the like. In one embodiment, the map database 103 may further store historical traffic data that includes travel times, average speeds and probe counts on each road or area at any given time of the day and any day of the year. According to some example embodiments, the road segment data records may be links or segments representing roads, streets, or paths, as may be used in calculating a route or recorded route information for determination of one or more personalized routes. The node data may be end points corresponding to the respective links or segments of road segment data. The road/link data and the node data may represent a road network, such as, used by vehicles, for example, cars, trucks, buses, motorcycles, and/or other entities. The road/link segments and nodes may be associated with attributes, such as geographic coordinates, street names, address ranges, speed limits, turn restrictions at intersections, and other navigation related attributes, as well as POIs, such as, fueling stations, hotels, restaurants, museums, stadiums, offices, auto repair shops, buildings, stores, parks, etc. The map database 103 may include data about the POIs and their respective locations in the POI records. The map database 103 may additionally include data about places, such as, cities, towns, or other communities, and other geographic features such as bodies of water, mountain ranges, etc. Such place or feature data may be part of the POI data or may be associated with POIs or POI data records (such as a data point used for displaying or representing a position of a city). In addition, the map database 103 may include event data (e.g., traffic incidents, construction activities, scheduled events, unscheduled events, etc.,) associated with the POI data records or other records of the map database 103 associated with the mapping platform 101. Optionally, the map database 103 may contain path segment and node data records or other data that may represent pedestrian paths or areas in addition to or instead of the autonomous vehicle road record data.

A content provider such as a map developer may maintain the mapping platform 101. By way of example, the map developer may collect geographic data to generate and enhance the mapping platform 101. There may be different ways used by the map developer to collect data. These ways may include obtaining data from other sources, such as municipalities or respective geographic authorities. In addition, the map developer may employ field personnel to travel by the autonomous vehicle along roads throughout the geographic region to observe features and/or record information about them, for example. Crowdsourcing of geographic map data may also be employed to generate, substantiate, or update map data. For example, sensor data from a plurality of data probes, which may be, for example, vehicles traveling along a road network or within a venue, may be gathered and fused to infer an accurate map of an environment in which the data probes are moving. Such sensor data may be updated in real time such as on an hourly basis, to provide accurate and up to date map data. The sensor data may be from any sensor that may inform a map database 103 of features within an environment that are appropriate for mapping. For example, motion sensors, inertia sensors, image capture sensors, proximity sensors, LIDAR (light detection and ranging) sensors, ultrasonic sensors etc. The gathering of large quantities of crowd-sourced data may facilitate the accurate modeling and mapping of an environment, whether it is a road segment or the interior of a multi-level parking structure. Also, remote sensing, such as aerial or satellite photography, may be used to generate map geometries directly or through machine learning.

The map database 103 of the mapping platform 101 may be a master map database stored in a format that facilitates updating, maintenance, and development. For example, the master map database or data in the master map database may be in an Oracle spatial format or other spatial format, such as for development or production purposes. The Oracle spatial format or development/production database may be compiled into a delivery format, such as a geographic data files (GDF) format. The data in the production and/or delivery formats may be compiled or further compiled to form geographic database products or databases, which may be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, and other functions, by a navigation device, for example. The navigation-related functions may correspond to vehicle navigation, pedestrian navigation, navigation to a favored parking spot or other types of navigation. While example embodiments described herein generally relate to vehicular travel and parking along roads, example embodiments may be implemented for bicycle travel along bike paths and bike rack/parking availability, boat travel along maritime navigational routes including dock or boat slip availability, etc. The compilation to produce the end user databases may be performed by a party or entity separate from the map developer. For example, a customer of the map developer, such as a navigation device developer or other end user device developer, may perform compilation on a received map database in a delivery format to produce one or more compiled navigation databases.

In some embodiments, the map database 103 may be a master geographic database configured at a server side, but in alternate embodiments, a client side map database 103 may represent a compiled navigation database that may be used in or with user devices, to provide navigation, speed adjustment and/or map-related functions to navigate through roadwork zones.

In one embodiment, a user device may be a device installed in the autonomous vehicle such as, an in-vehicle navigation system, an infotainment system, a control system of the electronics, or a mobile phone connected with the control electronics of the vehicle. In an embodiment, the user device may be an equipment in possession of the user of the autonomous vehicle, such as, a personal navigation device (PND), a portable navigation device, a cellular telephone, a smart phone, a personal digital assistant (PDA), a watch, a camera, a mobile computing device, such as, a laptop computer, a tablet computer, a mobile phone, a smart phone, a computer, a workstation, and/or other device that may perform navigation-related functions, such as digital routing and map display. The user device may be configured to access the map database 103 of the mapping platform 101 via a processing component through, for example, a user interface of a mapping application on the user device, such that the user device may provide navigational assistance and lane change action data to the user of the autonomous vehicle among other services provided through access to the mapping platform 101. The map database 103 may be used with the end user device, to provide the user of the autonomous vehicle with navigation features. In such a case, the map database 103 may be downloaded or stored on the user device which may access the mapping platform 101 through a wireless or wired connection, over the network 111.

The services platform 105 of the environment 100 may be communicatively coupled to the plurality of content providers 109a to 109j, via the network 111. In accordance with an embodiment, the services platform 105 may be directly coupled to the plurality of content providers 109a to 109j. The services platform 105, which may be used to provide navigation related functions and services 107a-107i to the system 113. The services 107a-107i may include navigation functions, speed adjustment functions, traffic related updates, weather related updates, warnings and alerts, parking related services, indoor mapping services and the like. The services 107a-107i may be provided by a plurality of content providers 109a-109j. In some examples, the content providers 109a-109j may access various SDKs from the services platform 105 for implementing one or more services. In an example, the services platform 105 and the mapping platform 101 may be integrated into a single platform to provide a suite of mapping and navigation related applications for OEM devices, such as the user devices and system 113. The system 113 may be configured to interface with the services platform 105, the content providers' services, and the mapping platform 101 over the network 111. Thus, the mapping platform 101 and the services platform 105 may enable provision of cloud-based services for the system 113, such as, storing the lane marking observations in the OEM cloud in batches or in real-time.

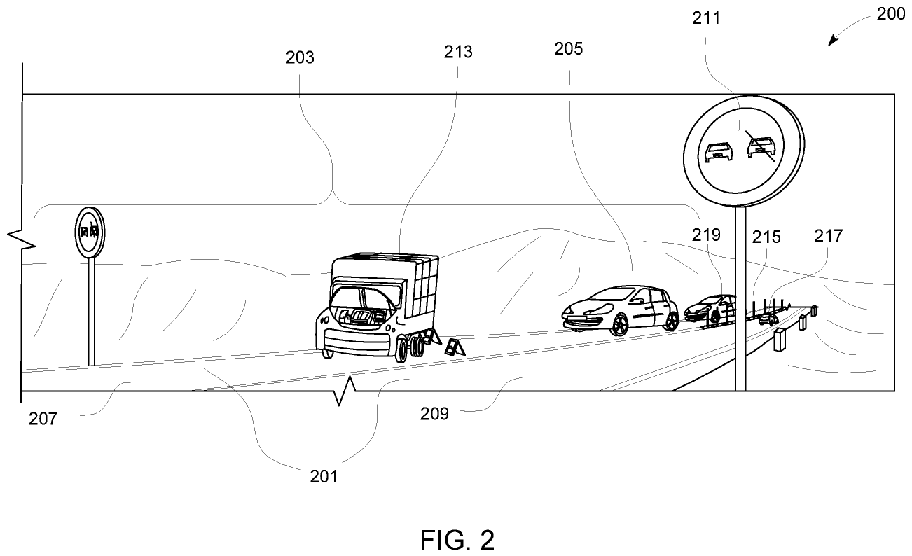

Further, in one embodiment, the system 113 may be a standalone unit configured to generate lane change action data for the autonomous vehicle in an overtake prohibited zone over the network 111. Alternatively, the system 113 may be coupled with an external device such as the autonomous vehicle. An exemplary embodiment, depicting an environment of the autonomous vehicle in the overtake prohibition zone is described in FIG. 2.

FIG. 2 illustrates a schematic diagram of an embodiment of an environment 200 for generating lane change action data for an autonomous vehicle, in accordance with an example embodiment. As per one embodiment of the disclosure, the environment 200 depicts a road 201 with an overtake prohibition zone 203, an autonomous vehicle 205, a current lane 207, a neighboring lane 209, a road object 211, and a blockage 213.

The road 201 may be a way leading the autonomous vehicle 205 from a source location to a destination location. In one example, the road 201 may comprise a single lane or multiple lanes, that is, the road may be a single lane road, a two lane road, or a four lane road. In an example, with respect to FIG. 2, the road 201 is a two lane road, which comprises a current lane 207 and a neighboring lane 209. In an embodiment, the two lanes of the road 201—the current lane 207 and the neighboring lane 209, may be separated by a physical divider 215. There may be traffic, such as, vehicles, pedestrians, bicycles, etc., plying on the neighboring lane 209 of the road 201. Further, as previously used, the road 201 includes the overtake prohibition zone 203, which indicates the restriction on action of going past another vehicle in the current lane 207. The overtake prohibition zone 203 includes the road object 211. In one example, the road object 211 is a “no overtake” sign board or a “no overtake” display. In an embodiment, the road object 211 may be lane markings indicating “no permission” to overtake. A broken-down vehicle 213 may cause a blockage or congestion of traffic on the road 201. The broken-down vehicle may be referred to as a blockage as indicated in the environment 200. The blockage 213 may hinder the speed of the autonomous vehicle 205 on the current lane 207. In an embodiment, the blockage 213 may be, but not limited to, a road accident, road construction work, a broken tree, and the like.

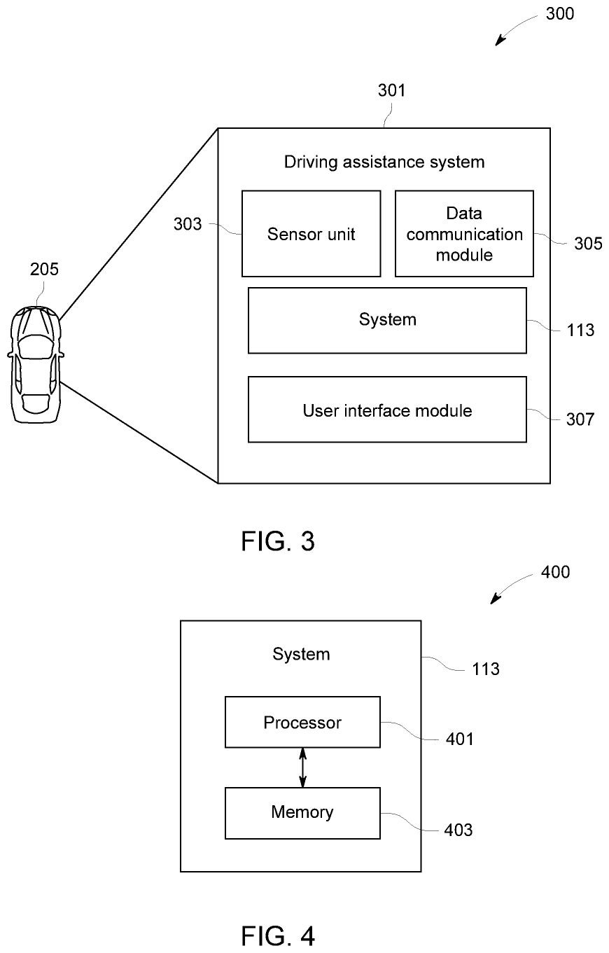

Further, as per some aspects of the disclosure, the autonomous vehicle 205 is communicatively coupled to the system 113 of FIG. 1, where the system 113 receives sensor data from the autonomous vehicle 205. Additionally or optionally, the system 113 receives map data from the map database 103. Based on the received sensor data and/or map data, the system 113 is configured to generate the lane change action data for the autonomous vehicle 205 located on the current lane 207. According to one embodiment, the autonomous vehicle 205 comprising the system 113 that is configured to generate the lane change action data, is described in reference to FIG. 3.

FIG. 3 illustrates a block diagram 300 of the autonomous vehicle 205 of FIG. 2 comprising a driving assistance system 301, in accordance with an example embodiment. The autonomous vehicle 205 comprises the driving assistance system 301 that facilitates navigation of the autonomous vehicle 205 from a source location to a destination location. The driving assistance system 301 may further comprise a sensor unit 303, a data communication module 305, the system, such as the system 113 of FIG. 1 and a user interface module 307.

The autonomous vehicle 205 may detect the road object 211, the blockage 213, the physical divider 215, the traffic 217 in the neighboring lane 209, etc., along the road 201. A plurality of road object observations may be captured by running vehicles, including the autonomous vehicle 205, plying on road 201 and the road object 211 is learnt from the road object observations, over a time period. The locations of the road object observations are recorded as those of the vehicles, including the autonomous vehicle 205, when they recognize and track the road object 211. The detection of the road object 211 by the vehicles, including the autonomous vehicle 205, is point based observations indicating location co-ordinates of the road object 211 within an area.

The road object 211 may be a static road sign or a variable road sign positioned along the road 201. Sign values of variable road sign, such as the extent of the overtake prohibition zone 203 may vary based on traffic conditions in vicinity of the variable road sign, such as, LCD display panels, LED panels, etc. In an embodiment, the sensor unit 303 of the driving assistance system 301 may be communicatively coupled to the system 113 via the network 111. In an embodiment, the sensor unit 303 of the driving assistance system 301 may be communicatively connected to an OEM cloud which in turn may be accessible to the system 113 via the network 111.

The sensor unit 303 may capture road object observations of the road object 211 along the road. The sensor unit may detect the blockage 213, the physical divider 215, the traffic 217 in the neighboring lane 209, the traffic 219 in the current lane 207, a speed and position of the autonomous vehicle 205, etc., along the road 201. The sensor unit 303 may comprise a camera for capturing images of the road object 211, the blockage 213, the physical divider 215, the traffic 217 in the neighboring lane 209, the traffic 219 in the current lane 207, etc., along the road 201, one or more position sensors to obtain location data of locations at which the images are captured, one or more orientation sensors to obtain heading data associated with the locations at which the images are captured, one or more motion sensors to obtain speed data of the autonomous vehicle 205 at the locations at which the images are captured. The location data may include one or more of a latitudinal position, a longitudinal position, height above a reference level, GNSS coordinates, proximity readings associated with a radio frequency identification (RFID) tag, or the like. The speed data may include rate of travel of the autonomous vehicle 205, the traffic 217 in the neighboring lane 209, or the traffic 219 in the current lane 207. The heading data may include direction of travel, cardinal direction, or the like of the autonomous vehicle 205, the traffic 219 in the current lane 207, the traffic 217 in the neighboring lane 209, etc. The sensor data may further be associated with a time stamp indicating the time of capture.

In one example, the sensor unit 303 comprises cameras, Radio Detection and Ranging (RADAR) sensors, and Light Detection and Ranging (LiDAR) sensors for generating sensor data. According to one embodiment, the cameras (alternatively referred as imaging sensors) may be used individually or in conjunction with other components for a wide range of functions, including providing a precise evaluation of speed and distance of the autonomous vehicle 205. Also, the cameras may be used for determining the presence of objects in an environment around the autonomous vehicle 205 via their outlines. Further, according to another embodiment, the RADAR sensors detect objects in the surrounding environment by emitting electromagnetic radio waves and detecting their return by a receiver. The RADAR sensors may be primarily used to monitor the surrounding traffic. In one example, the RADAR sensors may be a short range RADAR and/or a long range RADAR, where the long-range RADAR sensors are used to collect accurate and precise measurements for speed, distance and angular resolution of other vehicles on the road, such as the road 201. In one example, both the long range and short range RADAR sensors are used in the autonomous vehicle 205. Furthermore, according to another embodiment, the LiDAR sensors used in the autonomous vehicle 205, use a remote sensing method that uses light in the form of a pulsed laser to measure variable distances of objects from the autonomous vehicle 205.

The sensor unit 303 may further include sensors, such as, an acceleration sensor, a gyroscopic sensor, a LIDAR sensor, a proximity sensor, a motion sensor, a speed sensor and the like. The sensor unit 303 may use communication signals for position determination. The sensor unit 303 may receive location data from a positioning system, a Global Navigation Satellite System, such as, Global Positioning System (GPS), Galileo, GLONASS, BeiDou, etc., cellular tower location methods, access point communication fingerprinting, such as, Wi-Fi or Bluetooth based radio maps, or the like. The sensor unit 303, thus, generates sensor data corresponding to the location, heading, value, and type of the road object 211, the blockage 213, the physical divider 215, the presence of traffic 217 in the neighboring lane 209, the speed and position of the traffic 217 in the neighboring lane 209, the speed and position of the autonomous vehicle 205, etc., along the road 201. In an embodiment, the sensor unit 303 may transmit the generated sensor data to the OEM cloud.

In one embodiment, the data communication module 305 facilitates communication of the driving assistance system 301 with the external device(s), such as, the mapping platform 101, the map database 103, the services platform 105, the plurality of content providers 109a to 109j, and the network 111, disclosed in the detailed description of FIG. 1 and may receive the map data corresponding to the road (such as the road 201) on which the autonomous vehicle 205 is located. In one example, the map data may include, but not limited to, location co-ordinates data of the road 201, lane data, speed limit data of each lane, cartographic data, routing data, maneuvering data, real time traffic condition data and historical traffic data. The data communication module 305 may provide a communication interface for accessing various features and data stored in the system 113. In one embodiment, map data may be accessed using the user interface module 307 of the driving assistance system 301 disclosed herein. The user interface module 307 may render a user interface, for example, the generated lane change action data on the user device. In some example embodiments, the user interface module 307 may render notification about changes in navigation routes due to the blockage, etc., and impact of the blockage on parking situations, in mobile applications or navigation applications used by the users of the autonomous vehicle 205.

The user interface module 307 may in turn be in communication with the system 113 to provide output to the user and, in some embodiments, to receive an indication of a user input. In some example embodiments, the user interface module 307 may communicate with the system 113 and display input and/or output of the system 113. As such, the user interface 307 may include a display and, in some embodiments, may also include a keyboard, a mouse, a joystick, a touch screen, touch areas, soft keys, one or more microphones, a plurality of speakers, or other input/output mechanisms. In one embodiment, the system 113 may comprise user interface circuitry configured to control at least some functions of one or more user interface elements such as a display and, in some embodiments, a plurality of speakers, a ringer, one or more microphones and/or the like. Internal circuitry of the system 113 configured to generate lane change action data for the autonomous vehicle 205 is exemplarily illustrated in FIG. 4.

FIG. 4 illustrates a block diagram 400 of the system 113 generating the lane change action data for the autonomous vehicle 205 of FIG. 2, in accordance with an example embodiment. As exemplarily illustrated, the system 113 comprises at least one processor 401 and a storage means, such as, at least one memory 403. The memory 403 may store computer program code instructions and the processor 401 may execute the computer program code instructions stored in the memory 403.

Further, the processor 401 may be embodied in a number of different ways. For example, the processor 401 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 401 may include one or more processing cores configured to perform independently. A multi-core processor may enable multiprocessing within a single physical package. Additionally or alternatively, the processor 401 may include one or more processors configured in tandem via the bus to enable independent execution of instructions, pipelining and/or multithreading.

Additionally or alternatively, the processor 401 may include one or processors capable of processing large volumes of workloads and operations to provide support for big data analysis. In an example embodiment, the processor 401 may be in communication with the memory 403 via a bus for passing information among components of the system 113. The memory 403 may be non-transitory and may include, such as, one or more volatile and/or non-volatile memories. In other words, for example, the memory 403 may be an electronic storage device (for example, a computer readable storage medium) that comprises gates configured to store data (for example, bits). The data may be retrievable by a machine (for example, a computing device like the processor 401). The memory 403 may be configured to store information, data, content, applications, instructions, or the like, for enabling the system 113 to carry out various functions in accordance with an example embodiment of the present invention. For example, the memory 403 is configured to buffer input data for processing by the processor 401. As exemplarily illustrated in FIG. 4, the memory 403 could be configured to store instructions for execution by the processor 401. As such, whether configured by hardware or software methods, or by a combination thereof, the processor 401 may represent an entity (for example, physically embodied in circuitry) capable of performing operations according to an embodiment of the present invention while configured accordingly. Thus, for example, when the processor 401 is embodied as an ASIC, FPGA or the like, the processor 401 may be specifically configured hardware for conducting the operations described herein.

Alternatively, as another example, when the processor 401 is embodied as an executor of software instructions, the instructions may specifically configure the processor 401 to perform the algorithms and/or operations described herein when the instructions are executed. However, in some cases, the processor 401 may be a processor specific device (for example, a mobile terminal or a fixed computing device) configured to employ an embodiment of the present invention by further configuration of the processor 401 by instructions for performing the algorithms and/or operations described herein. The processor 401 may include, among other things, a clock, an arithmetic logic unit (ALU) and logic gates configured to support operation of the processor 401.

According to one embodiment, the processor 401 may receive the sensor data, generated by the sensor unit 303 of FIG. 3 and the map data, stored in the map database 103 of FIG. 1 via the data communication module 305 of the driving assistance system 301. Based on received sensor data and the map data, the processor 401 may generate lane change action data for the autonomous vehicle 205. The processor 401 may receive road object data of the current lane 207 of the autonomous vehicle 205 as part of the sensor data. In one example, the processor 401 may process the received sensor data and the map data to determine the road object data corresponding to the road object 211 of FIG. 2. For example, the sensor unit 303 on the autonomous vehicle 205 may capture the presence of a road object, such as the road object 211. The processor 401, in one example, may use edge detection techniques to identify the road object 211 and obtain road object data. The road object data may indicate a “no-overtake” instruction and an extent of the overtake prohibition zone 203. According to the edge detection technique, pixels related to an individual object will be relatively similar, but pixels related to different objects will be relatively different. Thus, by calculating the difference pixel-to-pixel, the edge for the road object 211 may be drawn. In an alternative embodiment, in the absence of the road object 211, the processor 401 may notify the driving assistance system 301 of the autonomous vehicle 205 and the user to continue navigating in the current lane 207.

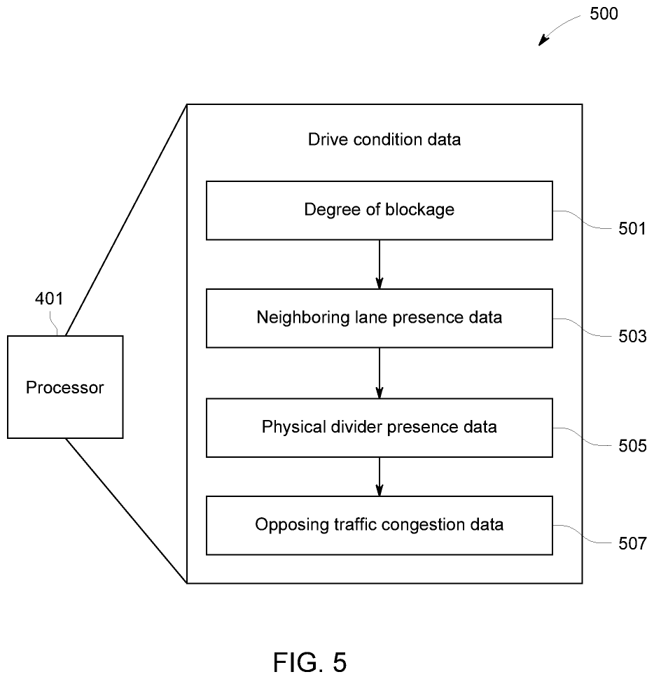

Further, the processor 401 may determine drive condition data of the autonomous vehicle 205, based on the generated road object data. In one example, the processor 401 generates the drive condition data through multiple steps in order of priority as exemplarily illustrated in FIG. 5. Based on the drive condition data, the processor 401 may generate the lane change action data as disclosed in the detailed description of FIG. 5.

FIG. 5 illustrates a flow diagram 500 for the process of determining the drive condition data by the processor 401 of the system 113, in accordance with an example embodiment. The process is defined to generate the drive condition data under multiple steps in order of priority, according to an exemplary embodiment. Further, the process of determining the drive condition data by the processor 401 comprises determining a degree of blockage 501, a neighboring lane presence lane data 503, a physical divider presence data 505, and an opposing traffic congestion data 507.

The processor 401 may determine the degree of blockage 501 of the current lane 207 (of FIG. 2). In one embodiment, the processor 401 may determine the degree of blockage 501 based on the identified road object data corresponding to the road object 211 associated with the current lane 207, based on the received sensor data and the map data. In one example, the processor 401 may identify a degree of blockage by comparing with a threshold level of blockage. In one example, the autonomous vehicle 205 may be at standstill, that is, at zero speed, when the degree of blockage is greater than or equal to a threshold level of blockage. The processor 401 may identify seized movement of the autonomous vehicle 205 from the speed data of the autonomous vehicle 205 and the speed data of the traffic 219 in the current lane 207. Alternatively, the processor 401 may instruct the autonomous vehicle 205 may continue in the current lane 207 if the degree of blockage is less than the threshold level of blockage. In an exemplary embodiment, the blockage 213 may be defined as an object that hinders speed of the autonomous vehicle 205. Additionally, the threshold level of blockage is defined based on dimensions, such as, height and width of the blockage 213, extent of a roadwork zone, etc. In one example, the threshold of the blockage 213 may be defined as the clearance the blockage 213 provides to the autonomous vehicle 205 to pass around, pass through or pass over the blockage 213.

For example, consider the presence of a broken-down motor bike of width 1.5 feet on the current lane 207 of width 12 feet, the broken-down motor bike may be considered the blockage 213. The sensor unit 303 of the autonomous vehicle 205, for example, a car of about 6 feet width, notices the broken-down motor bike from a specific distance and the processor 401 of the autonomous vehicle 205 analyses the degree of blockage and concludes the degree of blockage is less than the threshold level of blockage as the motor bike would not seize the movement of the autonomous vehicle 205 in the current lane 207. On the other hand, if a broken-down truck of width 8 feet is parked on the current lane 207 that seizes the movement of the autonomous vehicle 205, then the processor 401 determines the degree of blockage to be greater than or equal to the threshold level of blockage.

In one embodiment, the processor 401 may generate an instruction to the autonomous vehicle 205, as a part of the lane change action data, to continue in the current lane 207, when the degree of blockage 501 is determined to be less than a threshold level of blockage. In an alternative embodiment, the processor 401 determines neighboring lane presence data 503 for the autonomous vehicle 205, based on the degree of blockage that is greater than or equal to a threshold level of blockage. In one example, the neighboring lane presence data 503 corresponds to data indicating presence or absence of a neighboring lane adjacent to the current lane 207, such as the neighboring lane 209, of the road 201.

The processor 401, by utilizing the received map data and the sensor data, determines the neighboring lane presence data 503. The processor 401 may determine the map data that corresponds to the location data, constituting the sensor data of the autonomous vehicle 205. In one example, the processor 401 may determine presence of the neighboring lane 209 adjacent to the current lane 207 of the road 201 from the map database 103. Alternatively, the processor 401 may determine more than one neighboring lane, such as, 209 adjacent to the current lane 207. Further, the processor 401 may generate a notification message, as a part of the lane change action data, indicating an absence of a neighboring lane, such as, 209 adjacent to the current lane 207 of the autonomous vehicle 205. In one example, the notification message may notify that the current lane is 207 is blocked and there may be possible delays in the commute time. In an embodiment, the processor 401 may determine presence of a neighboring lane 209 adjacent to the current lane 207 of the autonomous vehicle 205.

In another example, based on the indication of presence of a neighboring lane 209 adjacent to the current lane 207, the processor 401, may further determine physical divider presence data 505 for the autonomous vehicle 205. In one example, presence of a physical divider, for example, 215 between the current lane 207 and the neighboring lane 209 prohibits maneuver of the autonomous vehicle 205 from the current lane 207 to the neighboring lane 209. The processor 401 may determine presence or absence of the physical divider 215 based on the location data of the autonomous vehicle 205 and the map data corresponding to the road 201. In one example, the processor 401 may generate a notification message, as a part of the lane change action data, based on the physical divider presence data 505 indicating presence of a physical divider 215 between the current lane 207 and the neighboring lane 209. In one example, the notification message may notify that the current lane 207 is blocked and there is no option to change lane, thereby resulting in possible delays in the commute time.

In an embodiment, the processor 401 may determine absence of the physical divider 215 between the current lane 207 and the neighboring lane 209. Furthermore, based on the absence of the physical divider 215 between the current lane 207 and the neighboring lane 209, the processor 401, by utilizing the received map data and the sensor data, determines the opposing traffic congestion data 507 on the neighboring lane 209. In one example, the opposing traffic congestion data 507 may indicate presence of traffic 217, such as, vehicular traffic, pedestrian traffic, etc., in the neighboring lane 209 and the volume of the traffic 217, if the traffic 217 is present in the neighboring lane 209. The volume of traffic may refer to the number of vehicles present on the neighboring lane 209, the rate of travel of the vehicles in the neighboring lane 209, etc. In an embodiment, the vehicles in the neighboring lane 209 may be moving in an opposite direction to that of the autonomous vehicle 205. In an embodiment, the vehicles in the neighboring lane 209 may be moving in the same direction as that of the autonomous vehicle 205. In one example, the processor 401, may generate a lane change notification, as a part of the lane change action data based on the opposing traffic congestion data 507 that indicates opposing traffic congestion less than or equal to a threshold level of opposing traffic congestion. In one example, the threshold level of opposing traffic congestion may be defined as absence of one or more vehicles in an area of the neighboring lane 209. Additionally, the area of the neighboring lane 209 may be equal to a length of the autonomous vehicle 205 with additional clearance and a width of the autonomous vehicle 205 with additional clearance that enables smooth transfer of the autonomous vehicle 205 from the current lane 207 to the neighboring lane 209. In an embodiment, the processor 401, as a part of generating the lane change action data, may generate an await notification, based on the opposing traffic congestion data 507 that indicates opposing traffic congestion in the neighboring lane 209 is greater than a threshold level of opposing traffic congestion. Alternately, the processor 401, as a part of the generating the lane change action data, may generate a lane change notification, instructing the autonomous vehicle 205 to move to neighboring lane 209 from the current lane 207, based on the opposing traffic congestion data 507 that indicates opposing congestion in the neighboring lane 209 is less than or equal to the threshold level of opposing traffic.

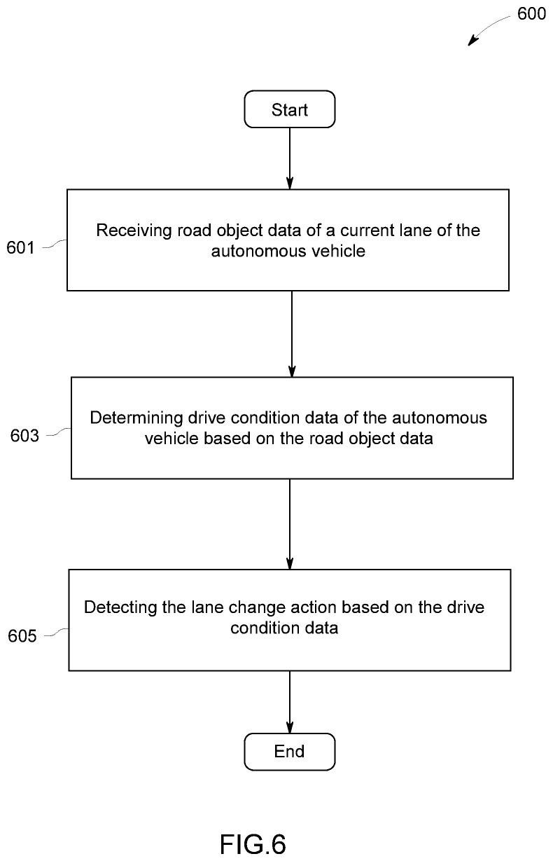

FIG. 6 shows a block diagram representing a method 600 for generating lane change action data for the autonomous vehicle 205, in accordance with one embodiment of the invention. It will be understood that each block of the flow diagram may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by the memory 403 of the system 113 of FIG. 4, employing an embodiment of the present invention and executed by a processor 401 of the system 113. As will be appreciated, any such computer program instructions may be loaded onto a computer or other programmable apparatus (for example, hardware) to produce a machine, such that the resulting computer or other programmable apparatus implements the functions specified in the flow diagram blocks. The computer program instructions may also be stored in a computer-readable memory 403 that may direct a computer or other programmable apparatus to function in a particular manner, such that the instructions stored in the computer-readable memory 403 produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

The method 600 starts at 601, by receiving road object data of a current lane 207 of the autonomous vehicle 205, wherein the road object data corresponds to a “no-overtake” instruction in the current lane 207. At 603, the method 600 includes a step of determining drive condition data of the autonomous vehicle 205, based on the road object data. Further, at 605, the method 600 includes a step of generating lane change action data for the autonomous vehicle 205, based on the drive condition data.

In an example embodiment, a system, such as, 113 for performing the method of FIG. 6 above may comprise a processor (e.g. the processor 401) configured to perform some or each of the operations (601-605) described above. The processor 401 may, for example, be configured to perform the operations (601-605) by performing hardware implemented logical functions, executing stored instructions, or executing algorithms for performing each of the operations. Alternatively, the system 113 may comprise means for performing each of the operations described above. In this regard, according to an example embodiment, examples of means for performing operations 601-605 may comprise, for example, the processor 401 and/or a device or circuit for executing instructions or executing an algorithm for processing information as described above. In some example embodiments, the system for performing the method of FIG. 6 may be the system 113 of FIG. 4.

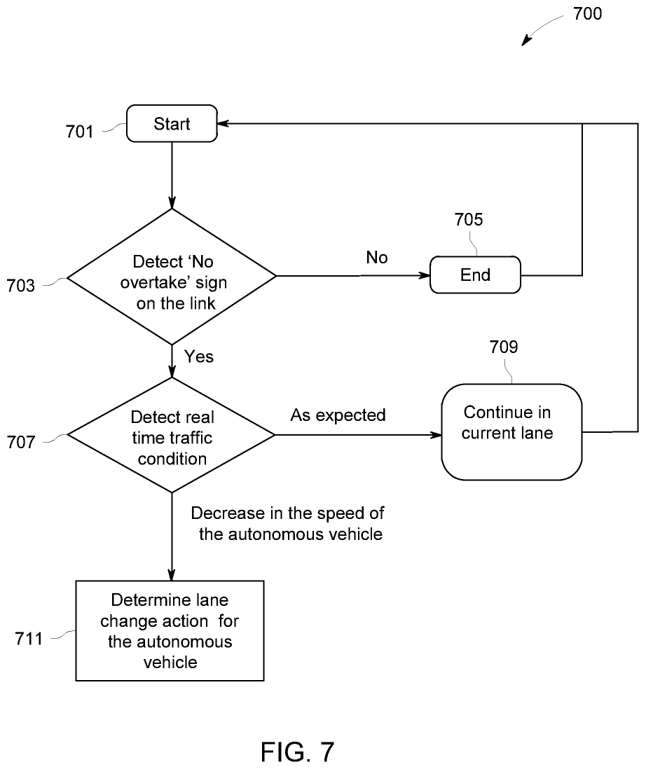

FIG. 7 shows a flow diagram representing a method 700 for generating lane change action data for the autonomous vehicle 205, in accordance with one embodiment of the invention. It will be understood that each block of a flow diagram may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by the memory 403 of the system 113 of FIG. 4, employing an embodiment of the present invention and executed by a processor 401 of the system 113. As will be appreciated, any such computer program instructions may be loaded onto a computer or other programmable apparatus (for example, hardware) to produce a machine, such that the resulting computer or other programmable apparatus implements the functions specified in the flow diagram blocks. The computer program instructions may also be stored in a computer-readable memory 403 that may direct a computer or other programmable apparatus to function in a particular manner, such that the instructions stored in the computer-readable memory 403 produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented method such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

At 701, the method 700 begins, when the autonomous vehicle 205 is present on the current lane 207. According to one embodiment, the driving assistance system 301 comprising the system 113 is communicatively coupled with the autonomous vehicle 205. At 703, the autonomous vehicle 205 detects the presence of a road object 211 such as a ‘no overtake sign’ and receive road object data. In one example, if the road object 211 is absent on the road 201, then the autonomous vehicle 205 ends the method at 705. Alternatively, if the autonomous vehicle 205 detects the presence of the road object 211, at 707, the autonomous vehicle 205 determines the real time traffic condition in the current lane 207. The real time traffic condition, in one example, may correspond to the degree of blockage on the current lane 207. In one example, at 709, if the degree of blockage is less than the threshold level of blockage or alternatively, if the real time traffic condition is as expected, the autonomous vehicle 205 generates the lane change action data that comprises generating an instruction to the autonomous vehicle 205 to continue in the current lane 207 in the autonomous mode.

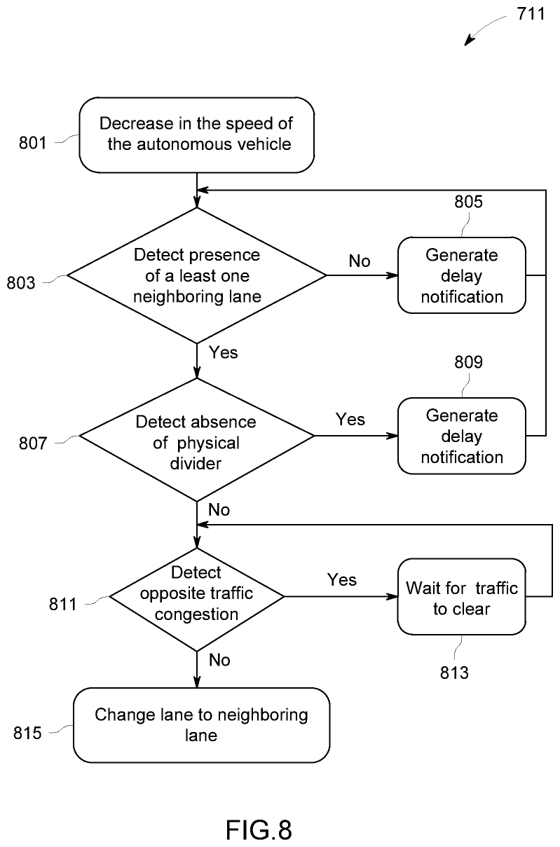

In another example, at 711, if the degree of blockage is greater than or equal to the threshold level of blockage, then the autonomous vehicle 205 generates the lane change action data as described in FIG. 8.

FIG. 8 shows a flow diagram 800 representing a method 711 of generating lane change action data, in accordance with one embodiment of the invention. At 801, the autonomous vehicle 205 detects the decrease in the speed of itself on the current lane 207. In one example, the decreased speed may be equal to zero. Based on the decreased speed, at 803, the autonomous vehicle 205 detects the presence of at least one neighboring lane, such as, the neighboring lane 209 adjacent to the current lane 207. If the autonomous vehicle 205 determines absence of the neighboring lane 209, then the autonomous vehicle 205, at 805, generates a delay notification that is communicated to the user devices associated with the users of the autonomous vehicle 205. Alternatively, the delay notification may be displayed on the user interface 307 of the driving assistance system 301.

Further, if the autonomous vehicle 205 detects the presence of the neighboring lane 209, then, at 807, the autonomous vehicle 205 detects for the absence of the physical divider 215. If the autonomous vehicle 205 determines presence of the physical divider 215, at 809, the autonomous vehicle 205 generates a delay notification. Alternatively, if the physical divider 215 is absent, at 811, the autonomous vehicle 205 may detect opposing traffic congestion or presence of traffic 217 in the neighboring lane 209. The autonomous vehicle 205 generates two possible outcomes on the detection of opposing traffic congestion in the neighboring lane 209. At 815, the autonomous vehicle 205 may generate a lane change notification, instructing the autonomous vehicle 205 to move to neighboring lane 209 from the current lane 207, since the opposing traffic congestion is less than or equal to a threshold level of opposing traffic congestion. Alternatively, at 813, the autonomous vehicle 205 may generate an “await traffic clearance” notification indicating the autonomous vehicle 205 to wait until the opposing traffic congestion in the neighboring lane 209 is cleared, since the opposing traffic congestion is determined to be greater than the threshold level of opposing traffic congestion.

Embodiments of the present disclosure described herein, provide the system 113 for a tangible generation of lane change action data for an autonomous vehicle. The autonomous vehicle does not involve manual interference and requires performing decisions to overtake or lane change diligently to avoid mishaps and casualties. However, overtaking traffic in a overtake prohibition zone on a road needs to be performed with utmost precision by the currently available autonomous vehicles. Overtaking or changing lane in the overtake prohibition zone is a very subjective decision, the autonomous vehicle is required to consider multiple environmental conditions, including real time traffic, lane congestion, opposing lane congestion, etc. Once the autonomous vehicle confirms that it is on road/link/segment where a “no overtake” sign is applicable, the autonomous vehicle determines whether the traffic is moving. The autonomous vehicle uses onboard sensors in real time, such as, cameras and real time traffic feed to confirm that real time traffic speed in the current lane is greater than 0 KPH. If the road that contains the “no overtake” sign is not blocked, that is, the traffic is moving or about to move in the current lane, then the autonomous vehicle remains in the current lane of travel and continue in the autonomous mode of driving. The autonomous vehicle takes such decisions swiftly, without any undue delay. In case the autonomous vehicle is required to be transitioned from the autonomous mode to the manual mode, such prioritization of environmental conditions including real time traffic, lane congestion, opposing lane congestion, etc., by the autonomous vehicle in a overtake prohibition zone is beneficial in a smooth transition of the vehicle between the different modes of driving. The present invention provides a driving assistance that is capable of detecting a blockage on the overtake prohibition zone from a specific distance, which gives the autonomous vehicle an edge to prioritize a decision more optimal for different road conditions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. A system for generating lane change action data for an autonomous vehicle, the system comprising:
a memory configured to store computer program code; and
one or more processors configured to execute the computer program code to:
receive road object data of a current lane of the autonomous vehicle, wherein the road object data corresponds to a no-overtake instruction in the current lane;
determine drive condition data of the autonomous vehicle, based on the road object data; and
generate the lane change action data, based on the drive condition data.

2. The system of claim 1, wherein to determine the drive condition data, the one or more processors are further configured to determine a degree of blockage of the current lane of the autonomous vehicle.

3. The system of claim 2, wherein to determine the drive condition data, the one or more processors are further configured to determine neighboring lane presence data for the autonomous vehicle, based on the degree of blockage that is greater than or equal to a threshold level of blockage.

4. The system of claim 3, wherein to determine the drive condition data, the one or more processors are further configured to determine physical divider presence data for the autonomous vehicle, based on the neighboring lane presence data that indicates presence of a neighboring lane adjacent to the current lane of the autonomous vehicle.

5. The system of claim 4, wherein to determine the drive condition data, the one or more processors are further configured to determine opposing traffic congestion data on the neighboring lane, based on the physical divider presence data that indicates absence of a physical divider between the current lane and the neighboring lane.

6. The system of claim 5, wherein to generate the lane change action data, the one or more processors are further configured to generate an instruction to the autonomous vehicle to transition from the current lane to the neighboring lane, based on the opposing traffic congestion data that indicates a degree of opposing traffic congestion is less than or equal to a threshold level of opposing traffic congestion.

7. The system of claim 5, wherein to generate the lane change action data, the one or more processors are further configured to generate a wait notification, based on the opposing traffic congestion data that indicates a degree of opposing traffic congestion is greater than a threshold level of opposing traffic congestion.

8. The system of claim 4, wherein to generate the lane change action data, the one or more processors are further configured to generate a notification message indicating possible delay, based on the physical divider presence data that indicates presence of a physical divider between the current lane and the neighboring lane.

9. The system of claim 3, wherein to generate the lane change action data, the one or more processors are further configured to generate a notification message indicating possible delay, based on the neighboring lane presence data that indicates absence of a neighboring lane adjacent to the current lane of the autonomous vehicle.

10. The system of claim 2, wherein to generate the lane change action data, the one or more processors are further configured to generate an instruction to the autonomous vehicle to continue in the current lane, based on the degree of blockage that is less than a threshold level of blockage.

11. A method for generating lane change action data, for an autonomous vehicle, the method comprising:
receiving, by one or more processors, road object data of a current lane of the autonomous vehicle, wherein the road object data corresponds to a no-overtake instruction in the current lane;
determining, by the one or more processors, drive condition data of the autonomous vehicle, based on the road object data; and
generating, by the one or more processors, the lane change action data, based on the drive condition data.

12. The method of claim 11, wherein determining the drive condition data further comprises determining a degree of blockage of the current lane of the autonomous vehicle.

13. The method of claim 12, wherein determining the drive condition data further comprises determining neighboring lane presence data for the autonomous vehicle, based on the degree of blockage that is greater than or equal to a threshold level of blockage.

14. The method of claim 13, wherein determining the drive condition data further comprises determining physical divider presence data for the autonomous vehicle, based on the neighboring lane presence data that indicates presence of a neighboring lane adjacent to the current lane of the autonomous vehicle.

15. The method of claim 14, wherein determining the drive condition data further comprises determining opposing traffic congestion data on the neighboring lane, based on the physical divider presence data that indicates absence of a physical divider between the current lane and the neighboring lane.

16. The method of claim 15, wherein generating the lane change action data further comprises generating an instruction to the autonomous vehicle to transition from the current lane to the neighboring lane, based on the opposing traffic congestion data that indicates a degree of opposing traffic congestion is less than or equal to a threshold level of opposing traffic congestion.

17. The method of claim 14, wherein generating the lane change action data further comprises generating a notification message indicating possible delay, based on the physical divider presence data that indicates presence of a physical divider between the current lane and the neighboring lane.

18. The method of claim 13, wherein generating the lane change action data further comprises generating a notification message indicating possible delay, based on the neighboring lane presence data that indicates absence of a neighboring lane adjacent to the current lane of the autonomous vehicle.

19. The method of claim 12, wherein generating the lane change action data further comprises generating an instruction to the autonomous vehicle to continue in the current lane, based on the degree of blockage that is less than a threshold level of blockage.

20. A computer program product comprising at least one non-transitory computer-readable storage medium having stored thereon computer-executable program code instructions which when executed by a computer, cause the computer to carry out operations for generating lane change action data for an autonomous vehicle, the operations comprising:
receiving, by one or more processors, road object data of a current lane of the autonomous vehicle;
determining, by the one or more processors, drive condition data of the autonomous vehicle, based on the road object data; and
generating, by the one or more processors, the lane change action data for the autonomous vehicle based on the drive condition data.
